(19) United States
(12) Patent Application Publication
(10) Pub. No.: US 2020/0386278 A1
(43) Pub. Date: Dec. 10, 2020

(54) CORE PLATE OF A FRICTION PLATE AND METHOD OF MAKING THE SAME

(71) Applicant: BorgWarner Inc., Auburn Hills, MI (US)

(72) Inventors: Paul H. Elsesser, Glen Ellyn, IL (US); David T. Vierk, Mokena, IL (US); Benjamin A. Siegel, Chicago, IL (US); Richard W. Pridgen, JR., Arlington Heights, IL (US)

(21) Appl. No.: 16/434,294

(22) Filed: Jun. 7, 2019

(51) Int. Cl. F16D 13/64; F16D 13/74; F16D 69/00

(52) U.S. Cl. CPC F16D 13/648; F16D 13/74; F16D 2250/0084; F16D 2069/009; F16D 69/00

(57) ABSTRACT

A friction plate includes a core plate. The core plate includes an interior core surface, an exterior core surface, a first clutch face having a first plane extending, and a second clutch face having a second plane. The friction plate also includes a friction material disposed on at least one of the first and second clutch faces. The core plate includes a plurality of projections. At least one of the projections extends away from the first and second planes with respect to the axis such that the at least one of the projections is configured to provide a spring force to the other friction plate of the clutch assembly during disengagement of the friction plate from the other friction plate, and to direct the lubricant axially away from the first clutch face along the axis during rotation of the core plate for limiting drag torque in the clutch assembly.

### BACKGROUND OF THE INVENTION

### 1. Field of the Invention

The present invention generally relates to a core plate of a friction plate and, more specifically, to a friction plate for use in a clutch assembly of a wet friction system, and a method of making a core plate of a friction plate.

### 2. Description of the Related Art

Several components of a motor vehicle powertrain may employ a wet friction system to facilitate the transfer of power from the motor vehicle's power generator (e.g., an internal combustion engine, electric motor, fuel cell, etc.) to drive wheels of the motor vehicle. A transmission, located downstream from the power generator that enables vehicle launch, gear shifting, and other torque transfer events, is one such component that may employ a wet friction system. Some form of a clutch assembly may be found throughout many different types of transmissions currently available for motor vehicle operation. A wet clutch may be utilized in a torque converter for an automatic transmission, in a multi-plate wet clutch pack for an automatic transmission or a semi-automatic dual-clutch transmission (DCT), and in a wet start clutch that may be incorporated into an automatic transmission equipped with as many as seven to ten gears as a substitute for the torque converter, to name but a few examples. Similar wet clutches may be found elsewhere in the vehicle powertrain besides the transmission.

The clutch assembly typically includes a plurality of friction plates rotatably coupled to a shaft, with the plurality friction plates being used to interlock two or more opposed, rotating surfaces in the presence of a lubricant by imposing selective interfacial frictional engagement between those surfaces. Each friction plate includes a core plate defining a bore for receiving the shaft such that each friction plate is rotatably coupled to the shaft. Each friction plate additionally includes a friction material disposed on the core plate, which effectuates the intended interlocking of frictional engagement between the plurality of friction plates. The presence of the lubricant cools and reduces wear of the friction material and permits some initial slip to occur so that torque transfer proceeds gradually, although very quickly, in an effort to avoid the discomfort that may accompany an abrupt torque transfer event (i.e., shift shock).

During operation, conventional friction plates move between an engaged position where the plurality friction plates are engaged with one another, and a disengaged position where the plurality friction plates are disengaged from one another. However, clutch assemblies including conventional friction plates often experience drag torque when the plurality of friction plates are rotating in the disengaged position, which is caused by the friction plates rotating through the lubricant. Increased drag torque reduces performance of the clutch assembly and, in turn, the wet friction system, and reduces fuel economy of the motor vehicle's power generator.

As such, there remains a need to provide an improved friction plate for a clutch assembly.

### SUMMARY OF THE INVENTION AND ADVANTAGES

A friction plate for use in a clutch assembly of a wet friction system includes a lubricant, with the clutch assembly including a shaft, and with the friction plate including a core plate defining a bore extending along an axis and adapted to receive and be rotatably coupled to the shaft. The core plate includes an interior core surface defining the bore, and an exterior core surface radially spaced from the interior core surface with respect to the axis such that the exterior core surface surrounds the interior core surface about the axis. The core plate also includes a first clutch face extending between the interior core surface and the exterior core surface and facing a first direction along the axis, with the first clutch face having a first plane extending along the first clutch face, and a second clutch face extending between the interior core surface and the exterior core surface and facing a second direction opposite the first direction along the axis, with the second clutch face having a second plane extending along the second clutch face. The friction plate also includes a friction material disposed on at least one of the first and second clutch faces. The core plate includes a plurality of projections along the exterior core surface extending radially away from the axis. At least one of the projections extends away from the first and second planes with respect to the axis such that the first plane is disposed between the at least one of the projections and the second plane with respect to the axis, and such that the at least one of the projections is configured to provide a spring force to another friction plate of the clutch assembly during disengagement of the friction plate from the other friction plate, and to direct the lubricant axially away from the first clutch face along the axis during rotation of the core plate for limiting drag torque in the clutch assembly. A method of producing the core plate is also disclosed herein.

Accordingly, the core plate including a plurality of projections, with at least one of the projections extending away from a first and second plane with respect to an axis such that the first plane is disposed between the at least one of the projections and the second plane with respect to the axis, and such that the at least one of the projections is configured to provide a spring force to another friction plate of the clutch assembly during disengagement of the friction plate from the other friction plate, and to direct the lubricant axially away from a first clutch face along the axis during rotation of the core plate limits drag torque in the clutch assembly, which ultimately increases performance of the clutch assembly, and increases fuel economy.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a clutch assembly including a plurality of friction plates in a transmission;

FIG. 2A is a cross-sectional view of the plurality of friction plates, with the plurality of friction plates being in an engaged state;

FIG. 2B is a cross-sectional view of the plurality of friction plates, with the plurality of friction plates including a core plate and a friction material, and with the plurality of friction plates being in a disengaged state;

FIG. 3 is a perspective view of the friction plate, with the core plate including a plurality of projections along an exterior core surface extending radially away from an axis;

FIG. 4 is a side view of a plurality of core plates and a plurality of clamp plates, with each core plate being sandwiched between two clamp plates, and with the plurality of core plates and the plurality of clamp plates in a disengaged state;

FIG. 4A is a close-up view of FIG. 4;

FIG. 5 is a side view of the plurality of core plates and the plurality of clamp plates in an engaged state;

FIG. 6 is a flowchart of a method of making the core plate of the friction plate; and

FIG. 7 is a flowchart of the method of making the core plate of the friction plate according to another embodiment.

### DETAILED DESCRIPTION OF THE INVENTION

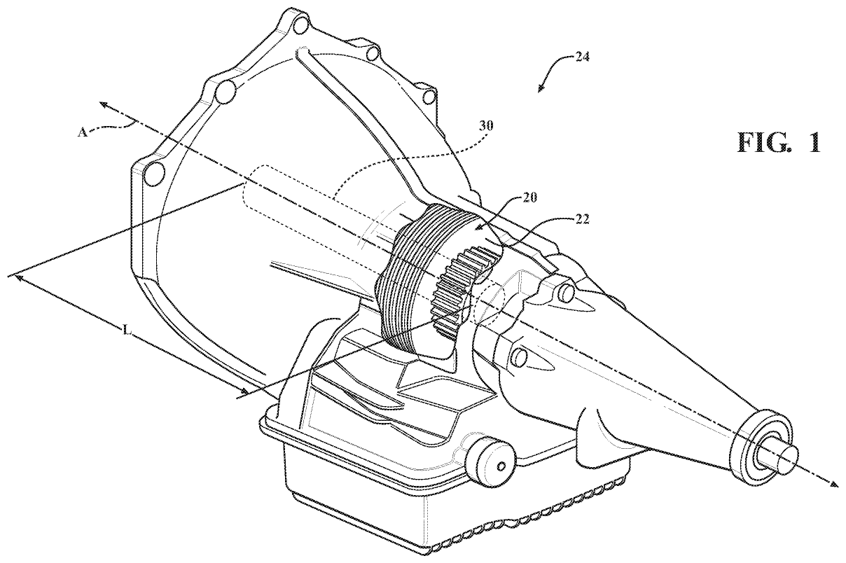

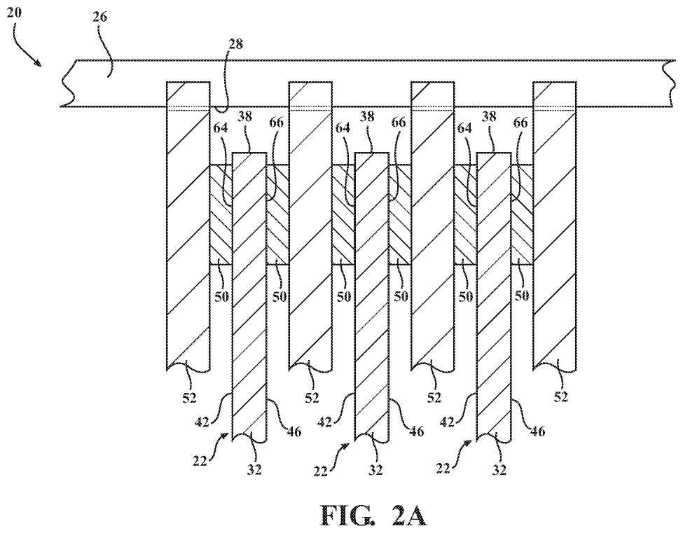

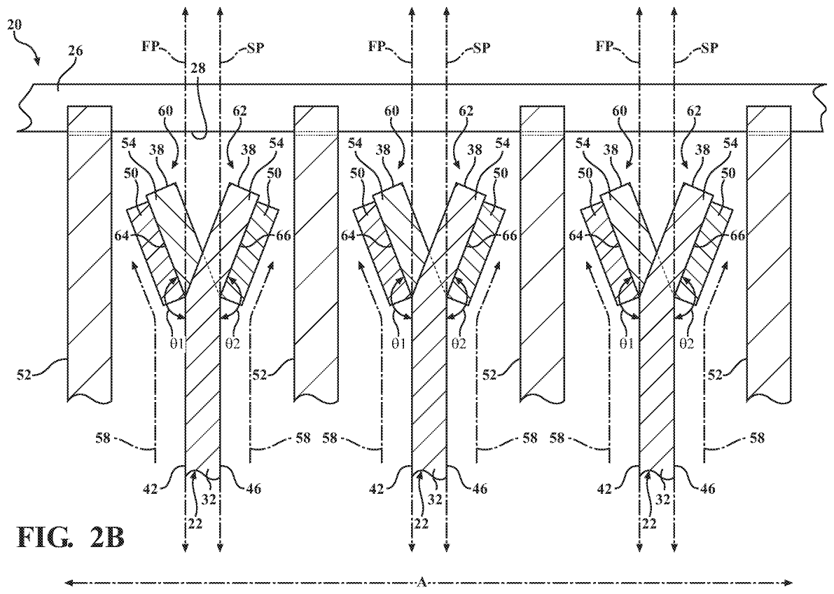

With reference to the Figures, wherein like numerals indicate like parts throughout the several views, a clutch assembly 20 including a friction plate 22 is generally shown in FIG. 1. The friction plate 22 is used in the clutch assembly 20 for use in a wet friction system 24. Examples of wet friction systems include transmissions, particularly automatic transmissions, continuously variable transmissions, automated manual transmissions, dual clutch transmissions, wet friction brake systems, and the like. With reference to FIGS. 2A and 2B, the clutch assembly 20 includes a housing 26 defining a clutch interior 28. The friction plate 22 is disposed in the clutch interior 28. With reference to FIG. 1, the clutch assembly 20 also includes a shaft 30 having a length L and an axis A extending along the length L.

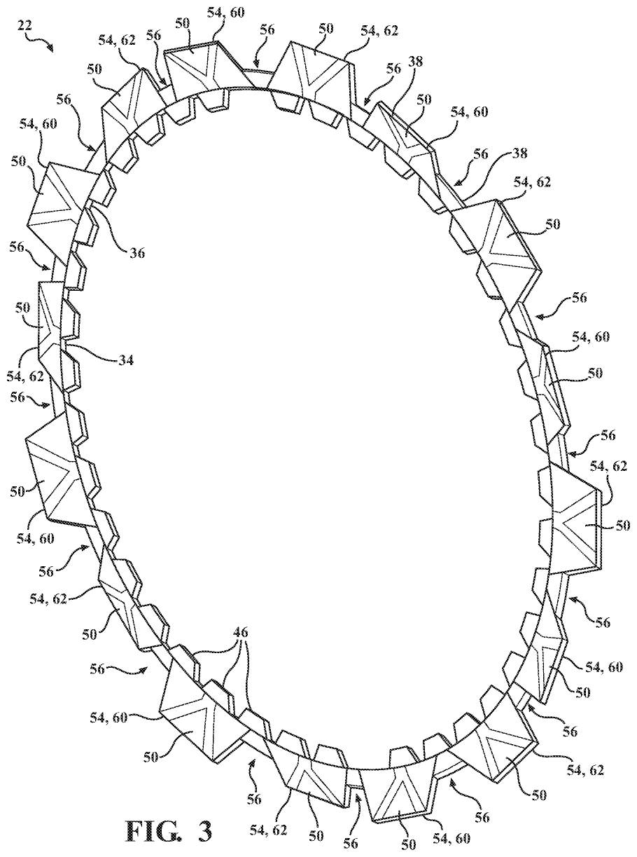

With reference to FIG. 3, the friction plate 22 includes a core plate 32 defining a bore 34 extending along the axis A. The bore 34 receives the shaft 30 such that the core plate 32 is rotatably coupled to the shaft 30. The shaft 30 is commonly referred to as a hub. The core plate 32 includes an interior core surface 36 defining the bore 34, and an exterior core surface 38 radially spaced from the interior core surface 36 with respect to the axis A such that the exterior core surface 38 surrounds the interior core surface 36 about the axis A. The core plate 32 typically includes a plurality of teeth 40 along the interior core surface 36 extending toward the axis A. The plurality of teeth 40, also commonly referred to as splines, are typically used for rotatably coupling the core plate 32 to the shaft 30. As shown in FIGS. 2A and 2B, the core plate 32 also includes a first clutch face 42 extending between the interior core surface 36 and the exterior core surface 38 and facing a first direction along the axis A, with the first clutch face 42 having a first plane FP extending along the first clutch face 42. The core plate 32 further includes a second clutch face 46 extending between the interior core surface 36 and the exterior core surface 38 and facing a second direction opposite the first direction along the axis A, with the second clutch face 46 having a second plane SP extending along the second clutch face 46. Typically, the first and second planes FP, SP are parallel to one another. In other words, the first and second clutch faces 42, 46 are typically flat.

The friction plate 22 also includes a friction material 50 disposed on at least one of the first and second clutch faces 42, 46. Typically, the friction plate 22 includes the friction material 50 on both the first and second clutch faces 42, 46. However, it is to be appreciated that the friction plate 22 may have the friction material 50 on only one of the first and second clutch faces 42, 46. For example, when the clutch assembly 20 includes a plurality of friction plates 22, each of the friction plates 22 are disposed about the axis A such that clutch assembly 20 includes two friction plates 22 sandwiching the other friction plates 22 between one another with respect to the axis A. In such cases, each of the two friction plates 22 sandwiching the other friction plates 22 typically only have the friction material 50 on one of the first and second clutch faces 42, 46. Typically, the clutch assembly 20 includes a plurality of pressure plates 52 disposed between the friction plates 22. The plurality of pressure plates 52 help move the friction plates 22 between an engaged position, as shown in FIG. 2A, and a disengaged position, as shown in FIG. 2B. The plurality of pressure plates 52 may be commonly referred to as separator plates or reaction plates.

The core plate 32 includes a plurality of projections 54 along the exterior core surface 38 extending radially away from the axis A. The plurality of projections 54 may define a plurality of notches 56 therebetween. Typically, the plurality of projections 54 are disposed 360 degrees about the axis A. At least one of the projections 54 extends away from the first and second planes FP, SP with respect to the axis A such that the first plane FP is disposed between the at least one of the projections 54 and the second plane SP with respect to the axis A, and such that the at least one of the projections 54 is configured to provide a spring force to another friction plate 22 of the clutch assembly 20 during disengagement of the friction plate 22 from the other friction plate 22, and to direct the lubricant axially away from the first clutch face 42 along the axis A during rotation of the core plate 32 for limiting drag torque in the clutch assembly 20.

Having at least one of the projections 54 extending away from the first and second planes FP, SP with respect to the axis A such that the first plane FP is disposed between the at least one of the projections 54 and the second plane SP with respect to the axis A, and such that the at least one of the projections 54 is configured to provide a spring force to another friction plate 22 of the clutch assembly 20 during disengagement of the friction plate 22 from the other friction plate 22, and to direct the lubricant axially away from the first clutch face 42 along the axis A during rotation of the core plate 32 for limiting drag torque in the clutch assembly 20 limits drag torque, also known as open pack drag, in the clutch assembly 20. Limiting drag torque in the clutch assembly 20 ultimately increases performance of the clutch assembly 20, and increases fuel economy. Specifically, the at least one of the projections 54 extending away from the first and second planes FP, SP with respect to the axis A provides a spring force to another friction plate 22 of the clutch assembly 20 as the friction plates 22 move from an engaged position, as shown in FIG. 2A, to the disengaged position, as shown in FIG. 2B. Similarly, the at least one of the projections 54 extending away from the first and second planes FP, SP with respect to the axis A directs the lubricant axially such that the lubricant pushes each of the friction plates 22 axially away from each other to go from the engaged position, as shown in FIG. 2A, to the disengaged position, as shown in FIG. 2B. As shown in FIG. 2B, arrows 58 indicate lubricant flow, which helps force the friction plates 22 from the engaged position to the disengaged position, and helps space the friction plates 22 axially away from each other, which limits drag torque caused from the friction plates 22 rotating in the lubricant. Additionally, the core plate 32 including the at least one of the projections 54 extending away from the first and second planes FP, SP with respect to the axis A allows the core plate 32 to have various configurations for directing lubricant, as described in further detail below, rather than using the friction material 50 for directing the lubricant. The core plate 32 including the at least one of the projections 54 extending away from the first and second planes FP, SP with respect to the axis A rather than using the friction material 50 for directing the lubricant allows better engagement of the friction material 50 of various friction plates 22, because the friction material 50 may be designed solely for engagement rather than including various designs for directing lubricant. Specifically, the core plate 32 including the at least one of the projections 54 extending away from the first and second planes FP, SP with respect to the axis A rather than using the friction material 50 for directing the lubricant allows the friction material 50 to be designed optimally for other purposes, such as engagement, pressure distribution, and manufacturability. However, it is to be appreciated that the core plate 32 including the at least one of the projections 54 extending away from the first and second planes FP, SP with respect to the axis A may also be used in a friction plate 22 that also uses the friction material 50 for directing the lubricant axially away from at least one of the first and second clutch faces 42, 46.

The plurality of projections 54 may be integral, i.e., one-piece, with the core plate 32. The plurality of projections 54 may be a separate component coupled to the core plate 32, such as a ring or any other suitable component that is configured to provide a spring force to another friction plate 22 of the clutch assembly 20 during disengagement of the friction plate 22 from the other friction plate 22, and to direct the lubricant axially away from at least one of the first and second clutch faces 42, 46 along the axis A during rotation of the core plate 32. In such cases where the plurality of projections 54 is a separate component coupled to the core plate 32, the plurality of projections 54 may be coupled to the core plate 32 in any suitable manner, such as fastened or bonded. Additionally, when the plurality of projections 54 is a separate component coupled to the core plate 32, the separate component, such as the ring or any other suitable component, may be comprised of a metallic or polymeric material.

As shown in FIG. 3, the plurality of projections 54 may include a first group of projections 60 and a second group of projections 62. Each projection 54 of the first group of projections 60 extends away from the first and second planes FP, SP with respect to the axis such that the first plane FP is disposed between each projection 54 of the first group of projections 60 and the second plane SP with respect to the axis A. Each projection 54 of said second group of projections 62 extends away from the first and second planes FP, SP with respect to the axis A opposite the first group of projections 60 such that the second plane SP is disposed between each projection 54 of the second group of projections 62 and the first plane FP with respect to the axis A. In such embodiments, the first group of projections 60 is configured to provide a spring force to another friction plate 22 of the clutch assembly 20 during disengagement of the friction plate 22 from the other friction plate 22, and to direct the lubricant axially away from the first clutch face 42 along the axis during rotation of the core plate 32 for limiting drag torque in the clutch assembly 20. Similarly, in such embodiments, the second group of projections 62 is configured to provide a spring force to another friction plate 22 of the clutch assembly 20 during disengagement of the friction plate 22 from the other friction plate 22, and to direct the lubricant axially away from the second clutch face 46 along the axis A during rotation of the core plate 32 for limiting drag torque in the clutch assembly 20.

Typically, each projection 54 of the first group of projections 60 is disposed between two projections 54 of the second group of projections 62 about the axis such that each projection 54 of the plurality of projections 54 alternates about the axis A between extending away from the first and second planes FP, SP with respect to the axis such that the first plane FP is disposed between each projection 54 of the first group of projections 60 and the second plane SP, and extending away from the first and second planes FP, SP with respect to the axis A such that the second plane SP is disposed between each projection 54 of the second group of projections 62 and the first plane FP. The alternating of each projection 54 between extending away from the first and second planes FP, SP with respect to the axis such that the first plane FP is disposed between each projection 54 of the first group of projections 60 and the second plane SP, and extending away from the first and second planes FP, SP with respect to the axis A such that the second plane SP is disposed between each projection 54 of the second group of projections 62 and the first plane FP may be referred to as having a saw tooth configuration.

In one embodiment, the first and second groups of projections 54 include all projections 54 of the plurality of projections 54. The first group of projections 60 may include one half of the plurality of projections 54, and the second group of projections 62 may include the other half of the plurality of projections 54. For example, the first group of projections 60 may include eight projections 54, and the second group of projections 62 may include eight projections 54. However, it is to be appreciated that first group of projections 60 and second group of projections 62 may include any number of suitable projections 54, such as five, six, seven, nine, ten, eleven, or twelve projections 54.

In one embodiment, the first clutch face 42 has a first friction surface 64 presented by the plurality of projections 54, and the second clutch face 46 has a second friction surface 66 presented by the plurality of projections 54. In such embodiments, the friction material 50 is disposed on at least one of the first and second friction surfaces 64, 66. The friction material 50 may be disposed on both of the first and second friction surfaces 64, 66. When the friction material 50 is disposed on both the first and second friction surfaces 64, 66 the friction material may be disposed on the first friction surface 64 of each projection 54, and on the second friction surface 66 of each projection 54. It is to be appreciated that the friction material 50 may be partially embedded in the first and second friction surfaces 64, 66, or may be disposed on the first and friction surfaces 64, 66.

The first friction surface 64 of each projection 54 of the first group of projections 60 and the first clutch face 42 adjacent the interior core surface 36 may define a first angle θ1 therebetween. Similarly, the second friction surface 66 of each projection 54 of the second group of projections 62 and the second clutch face 46 adjacent the interior core surface 36 may define a second angle θ2 therebetween. It is to be appreciated that the first and second angles θ1, θ2 may be any suitable angle for the plurality of projections to provide a spring force to another friction plate 22 of the clutch assembly 20 during disengagement of the friction plate 22 from the other friction plate 22, and to direct the lubricant axially away from the first and second clutch faces 42, 46 for reducing drag torque in the clutch assembly 20. By way of a non-limiting example, the first and second angles θ1, θ2 may be between 0.05 and 1.50 degrees, 0.10 and 1.25 degrees, and 0.15 and 0.90 degrees. The first friction surface 64 of each projection 54 of the first group of projections 60 and the first clutch face 42 adjacent the interior core surface 36 may have a curved surface joining the first clutch face 42 and the first friction surface 64. Similarly, the second friction surface 66 of each projection 54 of the second group of projections 62 and the second clutch face 46 adjacent the interior core surface 36 may have a curved surface joining the second clutch face 46 and the second friction surface 66. Typically, when the first friction surface 64 and the first friction face 42 are joined by a curved surface, the curved surface typically has concave configuration.

The core plate 32 may be comprised of any suitable material for use in the wet friction system 24. For example, the core plate 32 may be comprised of a metallic material. For example, such metallic materials that may be used include stainless steel, mild carbon steel, aluminum, and may contain surface treatments such as phosphate coating, nickel coating, anodizing, and the like. As another example, the core plate 32 may be comprised of a polymeric material.

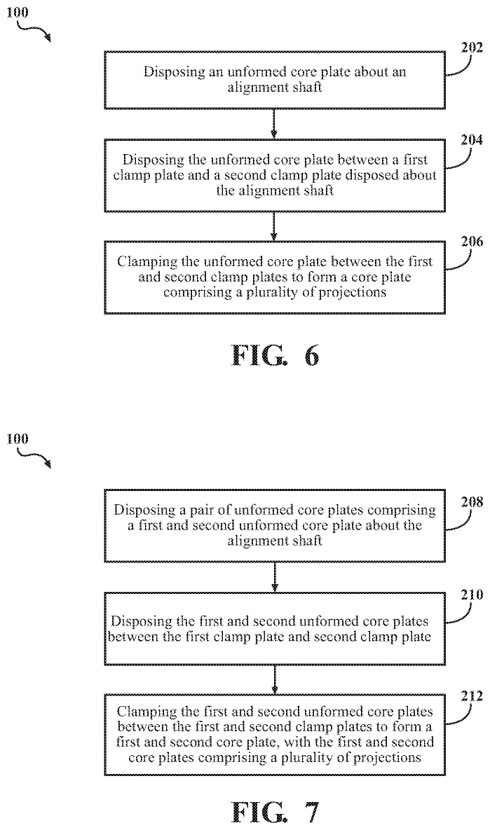

With reference to FIG. 6, a method 100 of making the core plate 32 of the friction plate 22 for use in the clutch assembly 20 in the wet friction system 24 includes the step of disposing an unformed core plate 68 about an alignment shaft 70, as indicated by box 202. It is to be appreciated that the unformed core plate 68 may include the friction material 50, and, therefore, an unformed friction plate may be used in the method 100. The unformed core plate 68 includes the interior core surface 36 defining the bore 34 extending along the axis A, and an exterior core surface 38 radially spaced from the interior core surface 36 with respect to the axis A such that the exterior core surface 38 surrounds the interior core surface 36 about the axis A. The unformed core plate 68 also includes the first clutch face 42 extending between the interior core surface 36 and the exterior core surface 38 and facing a first direction along the axis A, with the first clutch face 42 having the first plane FP extending along the first clutch face 42, and the second clutch face 46 extending between the interior core surface 36 and the exterior core surface 38 and facing a second direction opposite the first direction along the axis A, with the second clutch face 46 having the second plane SP extending along the second clutch face 46 parallel with the first plane FP.

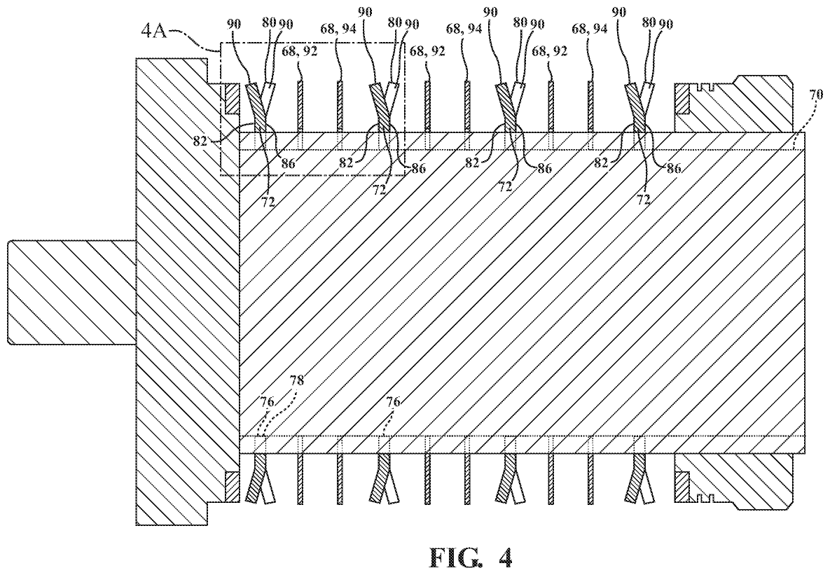

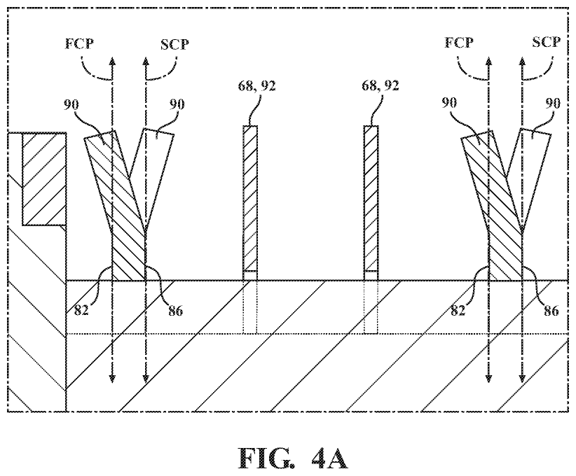

The method 100 further includes the step of disposing the unformed core plate 68 between a first clamp plate 72 and a second clamp plate 74 disposed about the alignment shaft 70, as indicated in box 204. The unformed core plate 68 is shown as being disposed between the first and second clamp plates 72, 74 in FIG. 4. The first and second clamp plates 72, 74 include an interior clamp surface 76 defining a clamp bore 78 along the axis A, and an exterior clamp surface 80 radially spaced from the interior clamp surface 76 with respect to the axis A such that the exterior clamp surface 80 surrounds the interior clamp surface 76 about the axis A. As shown in FIG. 4A, the first and second clamp plates 72, 74 include a first clamp face 82 extending between the interior clamp surface 76 and the exterior clamp surface 80 and facing the first direction along the axis A, with the first clamp face 82 having a first clamp plane FCP extending along the first clamp face 82, and a second clamp face 86 extending between the interior clamp surface 76 and the exterior clamp surface 80 and facing the second direction opposite the first direction along the axis A, with the second clamp face 86 having a second clamp plane SCP extending along the second clamp face 86 parallel with the first clamp plane FCP. The first and second clamp plates 72, 74 include a plurality of clamp projections 90 along the exterior clamp surface 80 extending radially away from the axis A. The at least one of the clamp projections 90 extend away from the first and second clamp planes FCP, SCP with respect to the axis A such that the first clamp plane FCP is disposed between the at least one of the clamp projections 90 and the second clamp plane SCP with respect to the axis A.

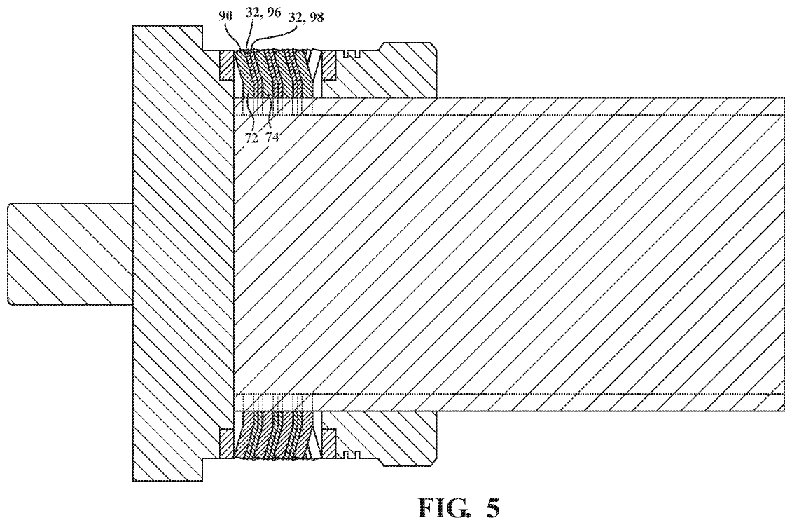

The method 100 further includes the step of clamping the unformed core plate 68 between the first and second clamp plates 72, 74 to form the core plate 32 including the plurality of projections 54 along the exterior core surface 38 extending radially away from the axis A, as indicated in box 206 of FIG. 6. The unformed core plate 68 is shown as being clamped between the first and second clamp plates 72, 74 in FIG. 5. The at least one of the projections 54 extends away from the first and second planes FP, SP with respect to the axis A such that the first plane FP is disposed between the at least one of the projections 54 and the second plane SP with respect to the axis A, and such that the at least one of the projections 54 is configured to provide a spring force to another friction plate 22 of the clutch assembly 20 during disengagement of the friction plate 22 from the other friction plate 22, and to direct the lubricant axially away from the first clutch face 42 along the axis A during rotation of the core plate 32 for limiting drag torque in the clutch assembly 20. It is to be appreciated that although two unformed core plates 68 are disposed between the first and second clamp plates 72, 74, that more than one unformed core plate 68 may be disposed between the first and second clamp plates 72, 74, such as two, three, four, or five unformed core plates 68.

In one embodiment, as shown in FIG. 7, the step 202 of disposing the unformed core plate 68 about the alignment shaft 70 is further defined as disposing a pair of unformed core plates including a first and second unformed core plates 92, 94 about the alignment shaft 70, as indicated by box 208. In such embodiments, the first clutch face 42 of the first unformed fore plate 92 is engaged with the second clutch face 46 of the second unformed fore plate 94. With continued reference to FIG. 7, the step 204 of disposing the unformed core plate 68 between the first clamp plate 72 and the second clamp plate 74 is further defined as disposing the first and second unformed core plates 92, 94 between the first clamp plate 72 and second clamp plate 74, as indicated by box 210. With continued reference to FIG. 7, the step 206 of clamping the unformed core plate 68 between the first and second clamp plates 72, 74 is further defined as clamping the first and second unformed core plates 92, 94 between the first and second clamp plates 72, 74 to form a first and second core plate 96, 98, as indicated by box 212. The first and second core plates 96, 98 are shown in FIG. 5. The first and second core plates 96, 98 include the plurality of projections 54 along the exterior core surface 38 extending radially away from the axis A. At least one of the projections 54 of the first and second core plates 96, 98 extends away from the first and second planes FP, SP with respect to the axis A such that the first plane FP is disposed between the at least one of the projections 54 and the second plane SP with respect to the axis A, and such that the at least one of the projections 54 is configured to provide a spring force to another friction plate 22 of the clutch assembly 20 during disengagement of the friction plate 22 from the other friction plate 22, and to direct the lubricant axially away from the first clutch face 42 along the axis A during rotation of the core plate 32 for limiting drag torque in the clutch assembly 20.

The method 100 may further include the step of disposing the friction material 50 on at least one of the first and second clutch faces 42, 46. As described above, it is to be appreciated that the friction material 50 may be disposed on both of the first and second clutch faces 42, 46, and that the friction material 50 may be disposed on the first and second friction faces 64, 66. The friction material 50 may be disposed on at least one of the first and second clutch faces 42, 46 prior to the step 202 of disposing the unformed core plate 68 about the alignment shaft 70. It is to be appreciated that the friction material 50 may be embedded in the first and second friction surfaces 64, 66, or may be disposed on the first and friction surfaces 64, 66. Typically, the core plates 32 are formed without the friction material 50. In other words, the friction material 50 is typically added to the core plate 32 after the plurality of projections 54 are formed.

In one embodiment, the step 206 of clamping the unformed core plate 68 between the first and second clamp plates 72, 74 occurs in a furnace set at any suitable temperature, such as between 800 and 1,000 degrees Fahrenheit, and the unformed core plate 68 and the first and second clamp plates 72, 74 may be in the furnace for any suitable time interval, such as between 30 to 120 minutes.

It is to be appreciated that other methods may be employed for making the core plate 32 of the friction plate 22. For example, the core plate 32 of the friction plate 22 may be formed by a stamping press, where the stamping press selectively bends at least one of the projections 54 to extend away from the first and second planes FP, SP with respect to the axis A such that the first plane FP is disposed between the at least one of the projections 54 and the second plane SP with respect to the axis A. As another example, the core plate 32 of the friction plate 22 may be formed by directing a laser at the core plate 32 to selectively bend the projections 54 to extend away from the first and second planes FP, SP with respect to the axis A such that the first plane FP is disposed between the at least one of the projections 54 and the second plane SP with respect to the axis A. When a laser is used to selectively bend at least one of the projections 54, at least a portion of the core plate 32 may be case hardened to cause at least one of the projections 52 to bend.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A friction plate for use in a clutch assembly of a wet friction system including a lubricant, with the clutch assembly including a shaft, said friction plate comprising:
a core plate defining a bore extending along an axis and adapted to receive and be rotatably coupled to the shaft, with said core plate comprising,
an interior core surface defining said bore,
an exterior core surface radially spaced from said interior core surface with respect to said axis such that said exterior core surface surrounds said interior core surface about said axis,
a first clutch face extending between said interior core surface and said exterior core surface and facing a first direction along said axis, with said first clutch face having a first plane extending along said first clutch face,
a second clutch face extending between said interior core surface and said exterior core surface and facing a second direction opposite said first direction along said axis, with said second clutch face having a second plane extending along said second clutch face; and
a friction material disposed on at least one of said first and second clutch faces;
wherein said core plate comprises a plurality of projections along said exterior core surface extending radially away from said axis, and wherein at least one of said projections extends away from said first and second planes with respect to said axis such that said first plane is disposed between said at least one of said projections and said second plane with respect to said axis, and such that said at least one of said projections is configured to provide a spring force to another friction plate of the clutch assembly during disengagement of said friction plate from the other friction plate, and to direct the lubricant axially away from said first clutch face along said axis during rotation of said core plate for limiting drag torque in the clutch assembly.

2. The friction plate as set forth in claim 1, wherein said plurality of projections comprises a first group of projections and a second group of projections, wherein each projection of said first group of projections extends away from said first and second planes with respect to said axis such that said first plane is disposed between each projection of said first group of projections and said second plane with respect to said axis, and wherein each projection of said second group of projections extends away from said first and second planes with respect to said axis opposite said first group of projections such that said second plane is disposed between each projection of said second group of projections and said first plane with respect to said axis, such that said first group of projections is configured to provide a spring force to the other friction plate of the clutch assembly during disengagement of said friction plate from the other friction plate, and to direct the lubricant axially away from said first clutch face along said axis during rotation of said core plate for limiting drag torque in the clutch assembly, and such that said second group of projections is configured to provide a spring force to the other friction plate of the clutch assembly during disengagement of said friction plate from the other friction plate, and to direct the lubricant axially away from said second clutch face along said axis during rotation of said core plate for limiting drag torque in the clutch assembly.

3. The friction plate as set forth in claim 2, wherein each projection of said first group of projections is disposed between two projections of said second group of projections about said axis such that each projection of said plurality of projections alternates about said axis between extending away from said first and second planes with respect to said axis such that said first plane is disposed between each projection of said first group of projections and said second plane, and extending away from said first and second planes with respect to said axis such that said second plane is disposed between each projection of said second group of projections and said first plane.

4. The friction plate as set forth in claim 2, wherein said first and second groups of projections include all projections of said plurality of projections.

5. The friction plate as set forth in claim 2, wherein said first group of projections includes one half of said plurality of projections, and wherein said second group of projections includes the other half of said plurality of projections.

6. The friction plate as set forth in claim 5, wherein said first group of projections includes eight projections, and wherein said second group of projections includes eight projections.

7. The friction plate as set forth in claim 1, wherein said first clutch face has a first friction surface presented by said plurality of projections, wherein said second clutch face has a second friction surface presented by said plurality of projections, and wherein said friction material is disposed on at least one of said first and second friction surfaces.

8. The friction plate as set forth in claim 7, wherein said friction material is disposed on both of said first and second friction surfaces.

9. The friction plate as set forth in claim 1, wherein said plurality of projections are disposed 360 degrees about said axis.

10. The friction plate as set forth in claim 1, wherein said core plate comprises a plurality of teeth along said interior core surface extending toward said axis.

11. The friction plate as set forth in claim 1, wherein said first and second planes are parallel to one another.

12. A clutch assembly for use in a wet friction system including a lubricant, said clutch assembly comprising:
a housing defining a clutch interior;
a shaft disposed in said clutch interior and having a length and an axis extending along said length; and
a friction plate disposed in said clutch interior, said friction plate comprising,
a core plate defining a bore extending along an axis, with said bore receiving said shaft such that said core plate is rotatably coupled to said shaft, with said core plate comprising,
an interior core surface defining said bore,
an exterior core surface radially spaced from said interior core surface with respect to said axis such that said exterior core surface surrounds said interior core surface about said axis,
a first clutch face extending between said interior core surface and said exterior core surface and facing a first direction along said axis, with said first clutch face having a first plane extending along said first clutch face,
a second clutch face extending between said interior core surface and said exterior core surface and facing a second direction opposite said first direction along said axis, with said second clutch face having a second plane extending along said second clutch face, and
a friction material disposed on at least one of said first and second clutch faces;
wherein said core plate comprises a plurality of projections along said exterior core surface extending radially away from said axis, and wherein at least one of said projections extends away from said first and second planes with respect to said axis such that said first plane is disposed between said at least one of said projections and said second plane with respect to said axis, and such that said at least one of said projections is configured to provide a spring force to another friction plate of the clutch assembly during disengagement of said friction plate from the other friction plate, and to direct the lubricant axially away from said first clutch face along said axis during rotation of said core plate for limiting drag torque in the clutch assembly.

13. The clutch assembly as set forth in claim 12, wherein said plurality of projections comprises a first group of projections and a second group of projections, wherein each projection of said first group of projections extends away from said first and second planes with respect to said axis such that said first plane is disposed between each projection of said first group of projections and said second plane with respect to said axis, and wherein each projection of said second group of projections extends away from said first and second planes with respect to said axis opposite said first group of projections such that said second plane is disposed between each projection of said second group of projections and said first plane with respect to said axis, such that said first group of projections is configured to provide a spring force to the other friction plate of the clutch assembly during disengagement of said friction plate from the other friction plate, and to direct the lubricant axially away from said first clutch face along said axis during rotation of said core plate for limiting drag torque in the clutch assembly, and such that said second group of projections is configured to provide a spring force to the other friction plate of the clutch assembly during disengagement of said friction plate from the other friction plate, and to direct the lubricant axially away from said second clutch face along said axis during rotation of said core plate for limiting drag torque in the clutch assembly.

14. The clutch assembly as set forth in claim 13, wherein each projection of said first group of projections is disposed between two projections of said second group of projections about said axis such that each projection of said plurality of projections alternates about said axis between extending away from said first and second planes with respect to said axis such that said first plane is disposed between each projection of said first group of projections and said second plane, and extending away from said first and second planes with respect to said axis such that said second plane is disposed between each projection of said second group of projections and said first plane.

15. The clutch assembly as set forth in claim 13, wherein said first and second groups of projections include all projections of said plurality of projections.

16. The clutch assembly as set forth in claim 12, wherein said first clutch face has a first friction surface presented by said plurality of projections, wherein said second clutch face has a second friction surface presented by said plurality of projections, and wherein said friction material is disposed on at least one of said first and second friction surfaces.

17. A method of making a core plate of a friction plate for use in a clutch assembly in a wet friction system, said method comprising:
disposing an unformed core plate about an alignment shaft, with the unformed core plate comprising,
an interior core surface defining a bore extending along an axis,
an exterior core surface radially spaced from the interior core surface with respect to the axis such that the exterior core surface surrounds the interior core surface about the axis,
a first clutch face extending between the interior core surface and the exterior core surface and facing a first direction along the axis, with the first clutch face having a first plane extending along said first clutch face, and
a second clutch face extending between the interior core surface and the exterior core surface and facing a second direction opposite the first direction along the axis, with said second clutch face having a second plane extending along said second clutch face parallel with the first plane;
disposing the unformed core plate between a first clamp plate and a second clamp plate disposed about the alignment shaft, with the first and second clamp plates comprising,
an interior clamp surface defining a clamp bore along the axis,
an exterior clamp surface radially spaced from the interior clamp surface with respect to the axis such that the exterior clamp surface surrounds the interior clamp surface about the axis,
a first clamp face extending between the interior clamp surface and the exterior clamp surface and facing the first direction along the axis, with the first clamp face having a first clamp plane extending along said first clamp face, and
a second clamp face extending between the interior clamp surface and the exterior clamp surface and facing the second direction opposite the first direction along the axis, with the second clamp face having a second clamp plane extending along the second clamp face parallel with the first clamp plane,
with the first and second clamp plates comprising a plurality of clamp projections along the exterior clamp surface extending radially away from the axis, and with the at least one of the clamp projections extending away from the first and second clamp planes with respect to the axis such that the first clamp plane is disposed between the at least one of the clamp projections and the second clamp plane with respect to the axis; and
clamping the unformed core plate between the first and second clamp plates to form a core plate comprising a plurality of projections along the exterior core surface extending radially away from the axis, wherein at least one of the projections extends away from the first and second planes with respect to the axis such that the first plane is disposed between the at least one of the projections and the second plane with respect to the axis, and such that the at least one of the projections is configured to provide a spring force to the other friction plate of the clutch assembly during disengagement of said friction plate from the other friction plate, and to direct the lubricant axially away from the first clutch face along the axis during rotation of the core plate for limiting drag torque in the clutch assembly.

18. The method as set forth in claim 17,
wherein the step of disposing an unformed core plate about an alignment shaft is further defined as disposing a pair of unformed core plates comprising a first and second unformed core plate about the alignment shaft, with first clutch face of the first unformed core plate engaged with the second clutch face of the second unformed core plate,
wherein the step of disposing the unformed core plate between the first clamp plate and the second clamp plate is further defined as disposing the first and second unformed core plates between the first clamp plate and second clamp plate, and
wherein the step of clamping the unformed core plate between the first and second clamp plates is further defined as clamping the first and second unformed core plates between the first and second clamp plates to form a first and second core plate, with the first and second core plates comprising a plurality of projections along the exterior core surface extending radially away from the axis, wherein at least one of the projections of the first and second core plates extends away from the first and second planes with respect to the axis such that the first plane is disposed between the at least one of said projections and the second plane with respect to the axis, and such that the at least one of the projections is configured to provide a spring force to the other friction plate of the clutch assembly during disengagement of said friction plate from the other friction plate, and to direct the lubricant axially away from the first clutch face along the axis during rotation of the core plate for limiting drag torque in the clutch assembly.

19. The method as set forth in claim 17, further comprising the step of disposing a friction material on at least one of the first and second clutch faces.

20. The method as set forth in claim 17, wherein the step of clamping the unformed core plate between the first and second clamp plates occurs in a furnace set between 800 and 1,000 degrees Fahrenheit for between 30 and 120 minutes.
